(19) United States
(12) Patent Application Publication
(10) Pub. No.: US 2026/0266947 A1
(43) Pub. Date: Sep. 10, 2026

(54) Method for Channel Correction and Target Speed Estimation for High Accuracy Distance Measurements

(71) Applicant: Silicon Laboratories Inc., Austin, TX (US)

(72) Inventor: Sauli Lehtimaki, Nummela (FI)

(21) Appl. No.: 19/070,748

(22) Filed: Mar. 5, 2025

(51) Int. Cl. G01S 5/02; H04L 25/02; H04W 4/02

(52) U.S. Cl. CPC G01S 5/0289; G01S 5/0244; H04L 25/022; H04W 4/023

(57) ABSTRACT

A system and method for determining the distance between two wireless network devices, wherein at least one of the devices may be moving, is disclosed. The system and method generate a corrected channel response. The information from the channel correction process may be used to identify the radial speed of the moving device. This radial speed is then used to compensate the measured channel response, such that the channel response is devoid of any radial speed component. In this way, any suitable algorithm may use the corrected channel response to determine the distance between the two devices. Importantly, the system and method can determine the radial speed within a single Channel Sounding procedure, thus reducing the time and battery power required to perform these calculations.

### FIELD

This disclosure describes systems and methods for determining the distance between two wireless network devices, and specifically, correcting the channel response and detecting a radial speed of a moving target based on information from the channel correction process.

### BACKGROUND

The Bluetooth protocol has designed several techniques to implement high accuracy distance measurement (HADM). These include a phase based ranging approach and a round trip time approach. Typically, there are two devices associated with these approaches; an initiator device that initiates the distance measurement and a reflector device, which responds to the initiator device. The distance being measured is the distance between these two devices.

In the round trip time (RTT) approach, each device uses timestamps. Specifically, when a packet is transmitted, the transmitting device records a transmit timestamp. When that packet arrives, a receive timestamp is used by the receiving device.

In the phase based approach, the initiator device determines the incoming phase for signals transmitted at two different frequencies. The phase measured (θᵢₙᵢₜ) at the initiator device may be approximately the difference in phase between the two devices (i.e. Δθᵢᵣ), added to the product 2π*f*(tp), where f is the frequency of the transmitted signal and tp is the trip delay. If this phase is measured at two different frequencies, and the difference is taken, the result is (θᵢₙᵢₜ₁)−(θᵢₙᵢₜ₂)=2π*f1*(tp)−2π*f2*(tp), or 2*π*(f1−f2)*(tp). Based on this equation, the trip delay may be calculated and then converted to a distance. This approach may be enhanced through the use of the multiple signal classification (MUSIC) algorithm. The MUSIC algorithm uses this information to generate pseudo-spectrums which may be used to determine the distance between the two devices.

However, these existing algorithms have limitations. For example, if one or both of the devices are moving, the calculated distance may be incorrect. In FIG. 9A, an ideal channel response is shown, where the phase of the incoming signal changes linearly with frequency. FIG. 9B shows the same two devices, separated by the same distance, where there is a radial speed component. Note that the slope of the graph is no longer smooth, the phase values at each frequency have increased and the frequency at which the phase wraps has moved. These changes may lead to incorrect calculations. Further, these techniques do not allow for the calculation of the relative speed of the moving device.

Consequently, a system and method that can determine the speed of the moving device would be beneficial. Further, it would be advantageous if the improved system did not require a large amount of computational processing and was able to provide this information quickly, such as from a single Channel Sounding procedure.

### SUMMARY

A system and method for determining the distance between two wireless network devices, wherein at least one of the devices may be moving, is disclosed. The system and method generate a corrected channel response. The information from the channel correction process may be used to identify the radial speed of the moving device. This radial speed is then used to compensate the measured channel response, such that the channel response is devoid of any radial speed component. In this way, any suitable algorithm may use the corrected channel response to determine the distance between the two devices. Importantly, the system and method can determine the radial speed within a single Channel Sounding procedure, thus reducing the time and battery power required to perform these calculations.

According to one embodiment, a method of calculating a radial speed between two wireless network devices is disclosed. The method comprises performing a Channel Sounding procedure at a plurality of frequencies to obtain a channel frequency response; and using the channel frequency response to determine the radial speed. In some embodiments, the channel frequency response is de-rotated using a plurality of different phase values to create a plurality of phase compensated channel frequency responses, and one of the plurality of different phase values is selected as a correct phase; and the radial speed is computed using the correct phase. In certain embodiments, the correct phase is a phase associated with the phase compensated channel frequency response determined to be the most smooth. In certain embodiments, determining the most smooth phase compensated channel frequency response comprises: applying a smoothing filter on each of the phase compensated channel frequency responses to create a plurality of smoothed responses; generating a plurality of error values by calculating a difference between each of the phase compensated channel frequency responses and their respective smoothed response; and determining the phase compensated channel frequency response associated with a smallest error to be the most smooth. In certain embodiments, the smoothing filter comprises a Savitsky-Golay filter or a moving average. In certain embodiments, the plurality of frequencies are not tested in ascending order in the Channel Sounding procedure, and the channel frequency response is sorted in accordance with increasing frequency prior to applying the smoothing filter. In certain embodiments, the plurality of different phase values comprise a range of equally spaced apart phase values. In certain embodiments, the plurality of different phase values comprises phase values calculated using a range of equally spaced apart radial speeds. In some embodiments, a corrected phase compensated channel frequency response is generated by eliminating the radial speed from the channel frequency response. In certain embodiments, a distance between the two wireless network devices is determined by utilizing a spectral analysis tool on the corrected phase compensated channel frequency response.

According to another embodiment, a Bluetooth network is disclosed. The network comprises a reflector device; and an initiator device, comprising: a Bluetooth network interface; a processing unit; and a memory device, wherein the memory device comprises instructions, which when executed by the processing unit, enable the initiator device to: calculate a channel frequency response at a plurality of frequencies; and use the channel frequency response to determine a radial speed between the initiator device and the reflector device. In some embodiments, the channel frequency response is de-rotated by the initiator device using a plurality of different phase values to create a plurality of phase compensated channel frequency responses, and one of the plurality of different phase values is selected as a correct phase; and the radial speed is computed using the correct phase. In certain embodiments, the correct phase is a phase associated with the phase compensated channel frequency response determined to be the most smooth. In certain embodiments, the initiator device comprises instructions to determine the most smooth phase compensated channel frequency response, wherein the instructions, when executed by the processing unit, enable the initiator device to: apply a smoothing filter on each of the phase compensated channel frequency responses to create a plurality of smoothed responses; generate a plurality of error values by calculating a difference between each of the phase compensated channel frequency responses and their respective smoothed response; and determine the phase compensated channel frequency response associated with a smallest error to be the most smooth. In certain embodiments, the smoothing filter comprises a Savitsky-Golay filter or a moving average. In certain embodiments, the plurality of frequencies are not tested in ascending order to create the channel frequency response, and wherein the channel frequency response is sorted by the initiator device in accordance with increasing frequency prior to applying the smoothing filter. In some embodiments, the plurality of different phase values comprise a range of equally spaced apart phase values. In some embodiments, the plurality of different phase values comprises phase values calculated using a range of equally spaced apart radial speeds. In some embodiments, the memory device further comprises instructions, which when executed by the initiator device, enable the initiator device to generate a corrected phase compensated channel frequency response by eliminating the radial speed from the channel frequency response. In certain embodiments, the memory device further comprises instructions, which when executed by the initiator device, enable the initiator device to determine a distance between the initiator device and the reflector device by utilizing a spectral analysis tool on the corrected phase compensated channel frequency response.

### BRIEF DESCRIPTION OF THE DRAWINGS

For a better understanding of the present disclosure, reference is made to the accompanying drawings, in which like elements are referenced with like numerals, and in which:

FIG. 1 is a block diagram of a representative initiator device that may estimate distance and radial speed according to one embodiment;

FIG. 2 shows a network having an initiator device and at least one reflector device according to one embodiment;

FIG. 3 shows a flowchart to determine the radial speed and generate a corrected phase compensated channel response according to one embodiment;

FIG. 4 shows a chronologically ordered channel response generated using a simulation that is not sorted in accordance with increasing frequency;

FIG. 5 shows the graph of FIG. 4 that has been sorted according to increasing frequency;

FIG. 6 shows the error as a function of phase correction;

FIG. 7 shows the graph of FIG. 5 that has been phase compensated;

FIG. 8 shows a flowchart to determine the radial speed and generate a corrected phase compensated channel response according to another embodiment;

FIGS. 9A-9B show the difference between channel responses when the two devices are stationary and when there is a radial speed component, respectively;

FIGS. 10A-10B show the phase uncompensated channel response according to another simulation and the corresponding spectral analysis, respectively;

FIGS. 11A-11B show the channel response and the smoothed channel response at two different values of phi;

FIG. 11C shows the error as a function of phase correction; and

FIGS. 12A-12B show the phase compensated channel response and the corresponding spectral analysis.

### DETAILED DESCRIPTION

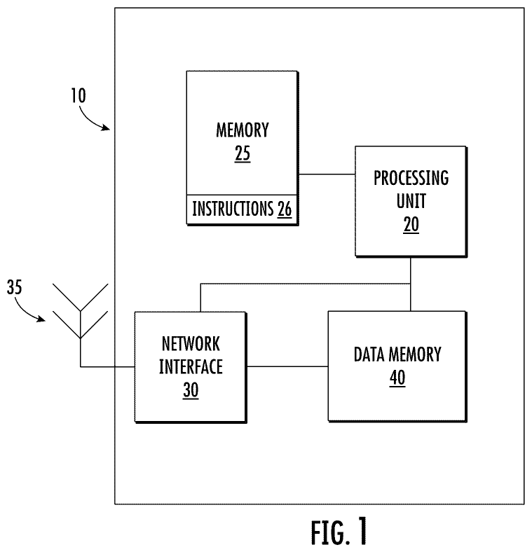

FIG. 1 shows a block diagram of a representative network device. This network device may serve as an initiator device 10, as described in more detail below. This network device may also be used to determine the distance to and the radial speed of a remote device, also referred to as a reflector device.

The initiator device 10 has a processing unit 20 and an associated memory device 25. The processing unit 20 may be any suitable component, such as a microprocessor, embedded processor, an application specific circuit, a programmable circuit, a microcontroller, or another similar device. This memory device 25 contains the instructions 26, which, when executed by the processing unit 20, enable the initiator device 10 to perform the functions described herein. This memory device 25 may be a non-volatile memory, such as a FLASH ROM, an electrically erasable ROM or other suitable devices. In other embodiments, the memory device 25 may be a volatile memory, such as a RAM or DRAM.

The initiator device 10 also includes a network interface 30, which may be a wireless interface including an antenna element 35.

The wireless signals first enter the network interface 30 through antenna element 35. The antenna element 35 is in electrical communication with a low noise amplifier (LNA). The LNA receives a very weak signal from the antenna element 35 and amplifies that signal while maintaining the signal-to-noise ratio (SNR) of the incoming signal. The amplified signal is then passed to a mixer. The mixer is also in communication with a local oscillator, which provides two phases to the mixer. The cosine of the frequency may be referred to as Iₒ, while the sin of the frequency may be referred to as Qₒ. The Iₒ signal is then multiplied by the incoming signal to create the inphase signal, Iₘ. The Qₒ signal is then multiplied by a 90° delayed version of the incoming signal to create the quadrature signal, Qₘ. The inphase signal, Iₘ, and the quadrature signal, Qₘ, from the mixer are then fed into programmable gain amplifier (PGA). The PGA amplifies the Iₘ and Qₘ signals by a programmable amount. These amplified signals may be referred to as I_{g} and Q_{g}. The amplified signals, I_{g} and Q_{g}, are then fed from the PGA into an analog to digital converter (ADC). The ADC converts these analog signals to digital signals, I_{d} and Q_{d}. These digital signals may then pass through a channel filter. The filtered signals are referred to as I and Q. These I and Q signals can be used to recreate the amplitude and phase of the original signal.

The network interface 30 may support any wireless network, such as Bluetooth, Wi-Fi, networks utilizing the IEEE 802.15.4 specification, such as Zigbee, networks utilizing the IEEE 802.15.6 specification, and wireless smart home protocols, such as Z-Wave. The network interface 30 is used to allow the initiator device to communicate with other devices disposed on the network.

The initiator device 10 may include a data memory device 40 in which data that is received and transmitted by the network interface 30 is stored. This data memory device 40 is traditionally a volatile memory. The processing unit 20 has the ability to read and write the data memory device 40 so as to communicate with the other nodes in the network. Although not shown, the initiator device 10 also has a power supply, which may be a battery or a connection to a permanent power source, such as a wall outlet.

While a memory device 25 is disclosed, any computer readable medium may be employed to store these instructions. For example, read only memory (ROM), a random access memory (RAM), a magnetic storage device, such as a hard disk drive, or an optical storage device, such as a CD or DVD, may be employed. Furthermore, these instructions may be downloaded into the memory device 25, such as for example, over a network connection (not shown), via CD ROM, or by another mechanism. These instructions 26 may be written in any programming language and is not limited by this disclosure. Thus, in some embodiments, there may be multiple computer readable media that contain the instructions described herein. The first computer readable media may be in communication with the processing unit 20, as shown in FIG. 1. The second computer readable media may be a CDROM, or a different memory device, which is located remote from the initiator device 10. The instructions contained on this second computer readable media may be downloaded onto the memory device 25 to allow execution of the instructions by the initiator device 10.

While the processing unit 20, the memory device 25, the network interface 30, and the data memory device 40 are shown in FIG. 1 as separate components, it is understood that some or all of these components may be integrated into a single electronic component. Rather, FIG. 1 is used to illustrate the functionality of the initiator device 10, not its physical configuration.

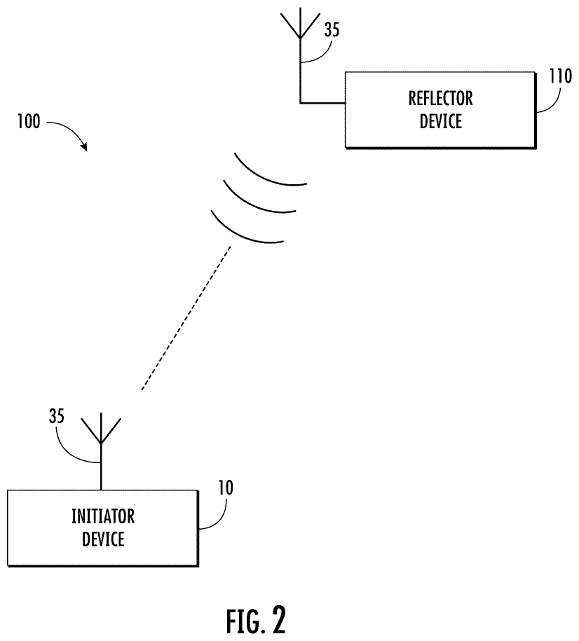

FIG. 2 shows a network 100 having at least one reflector device 110 and an initiator device 10. In certain embodiments, the reflector device 110 may be a network device and contain many of the components described above and shown in FIG. 1. However, the reflector device 110 may have a smaller amount of memory and may have less computational ability.

In FIG. 2, the initiator device 10 may transmit a signal, containing a sine wave having a first frequency to the reflector device 110. In response, the reflector device 110 may transmit a signal containing a sine wave having the same first frequency toward the initiator device 10.

In certain embodiments, this signal is transmitted using a network protocol, such as Bluetooth.

The initiator device 10 may utilize the I and Q signals described above to determine the amplitude and phase of the signal arriving at the antenna element 35. This information may then be used to calculate the distance from the initiator device 10 to the reflector device 110.

Specifically, the Bluetooth specification describes a Channel Sounding procedure, during which the initiator device 10 transmits a first signal at a first frequency to the reflector device 110. The reflector device 110 measures the magnitude and phase of the incoming first signal. In response, the reflector device 110 transmits a second signal having the first frequency back to the initiator device 10. The initiator device 10 measures the magnitude and phase of the incoming second signal. This may be repeated for a number of different frequencies. Based on the magnitude and phase information gathered by the initiator device 10 and the reflector device 110, the channel transfer function (H) may be estimated. Note that the term “channel transfer function” is synonymous with “channel frequency response”.

As a specific example, the Bluetooth specification defines the following procedure to determine the channel transfer function.

First, θ_{CH}(f) represents the phase delay of the channel, where f is the channel frequency, and Δθ_{LO}(f) represents the relative difference in phase of the RF carrier between the initiator device and the reflector device. Based on this, the relative phases of a carrier measured at the reflector and initiator's antenna is θ_{REFL} (f)=θ_{CH} (f)+Δθ_{LO} (f) and θ_{INIT} (f)=θ_{CH} (f)−Δθ_{LO} (f). A_{REFL} (f) and A_{INIT}(f) represent the amplitude of that measured carrier at the reflector and initiator's antenna, respectively. Phase correction term (PCT) is defined by the angle that, if added to the internal angle of the local oscillator, would result in a phase identical to that of the incoming signal. The I and Q values represented by the PCT measured at the reflector and initiator, respectively, are given by PCT_{REFL} (f)=A_{REFL} (f) e^{iθ}_{REFL} (f) and PCT_{INIT} (f)=A_{INIT} (f) e^{iθ}_{INIT} (f). If the communication channel is symmetrical between the initiator device 10 and the reflector device 110, the measured phases are dependent on both the communication channel and the relative difference in phase of the RF carrier between the devices. The communication channel transfer function can then be estimated from H²(f)=A_{REFL} (f) e^{iθ}_{REFL} (f)×A_{INIT} (f) e^{iθ}_{INIT} (f)=A_{CH}² (f) e^{i2θ}_{CH} (f).

The channel transfer function (also referred to as channel frequency response) may then be used to compute the distance between the initiator device 10 and the reflector device 110. Furthermore, the channel transfer function may also be used to determine the radial speed component between the initiator device 10 and the reflector device 110. In this example, it is assumed that the initiator device 10 is stationary, and the reflector device 110 is moving. However, this algorithm also works if the initiator device 10 is moving or both devices are moving. Note that in order to be detected, a component of the movement must be parallel to the direct path between the initiator device 10 and the reflector device 110. In other words, if the movement is such that the distance between the two devices does not change, this movement is inconsequential. In this disclosure, the component of the movement that is parallel to the direct path between the initiator device 10 and the reflector device 110 is referred to as radial movement or radial speed.

Note that the Bluetooth specification also mandates that the Channel Sounding procedure must randomize the order of the frequencies that are tested. Thus, the phase shift caused by the radial speed is not linearly increasing as a function of the frequency being tested during the Channel Sounding procedure.

One technique to determine the radial speed component is to de-rotate the channel transfer function using a plurality of different phases. Each de-rotation results in a graph that correlates measured phase to the frequency being tested. Ideally, the relationship between unwrapped phase and frequency should be roughly linear. Therefore, the phase that, when used to de-rotate the channel transfer function, results in the graph that is the most smooth, is likely the cause of the discontinuities. This phase can then be converted to a radial speed. Additionally, once this phase is determined, a compensated channel response may be created, where the compensated channel response does not include the radial speed component.

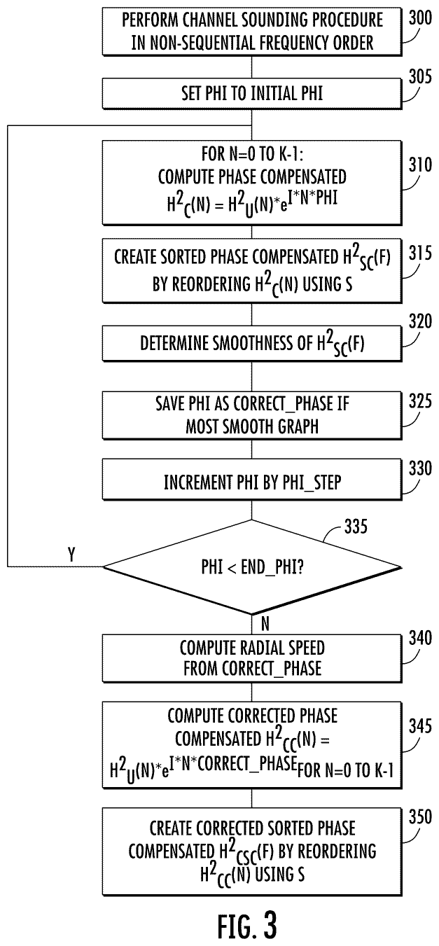

The process to determine this phase will now be described in more detail and is shown in FIG. 3.

First, as shown in Box 300, a Channel Sounding procedure is performed. The result of this procedure is a channel transfer function, referred to as H²(f), where, for each frequency used in the Channel Sounding procedure, there is an associated phase and amplitude. Note that the frequencies used in the Channel Sounding procedure is not tested in a sequential order. Thus, the chronologically ordered, but not frequency ordered, channel response may be defined as H²ᵤ(0:k−1), where k is the number of different frequencies that are tested. Further, the relationship between k (which is the order in which the frequencies were tested) and f, which is the frequency that was actually tested at measurement slot k, may be defined as f=S(k), where S defines the mapping of frequencies that were used to measurement slots. Note that while this description assumes that the channel response is H²(f), the algorithm also operates if the channel response is H(f).

Next, as shown in Box 305, an initial value of phi is determined. This may be done in a number of ways. In one embodiment, a broad range of values, such as −2π to +2π may be used. In another embodiment, a smaller range, such as −π to +π, or another range, may be used. In yet another embodiment, the range may be set based on the expected speed of the reflector device 110. For example, a simple relationship between phi (φ) and the radial speed may be expressed as:

$$φ = \frac{4 π {vt}_{s}}{λ}$$

where v is the radial speed, ts is the time between frequency measurements of the Channel Sounding procedure and λ is the wavelength, which may be the average wavelength of all frequencies used in the Channel Sounding procedure. In some embodiments, ts is between 100 μsec and 600 μsec, although other values may be used. Note that this equation assumed that the channel frequency response is H²(f). If H(f) is used, the numerator is reduced by a factor of two.

By establishing reasonable limits for the radial speed and using the above equation, a range of p values may be established.

Next, as shown in Box 310, a phase compensated channel frequency response is calculated by multiplying each element in H²ᵤ(0:k−1) by e^{i*k*φ}, wherein k is the chronological order that the frequencies were tested.

Once the phase compensated channel frequency response (H²ₑ(0:k−1)) is calculated, the channel frequency response is sorted in accordance with increasing frequencies, as shown in Box 315. This sorted compensated channel frequency response is referred to as H²_{sc}(f).

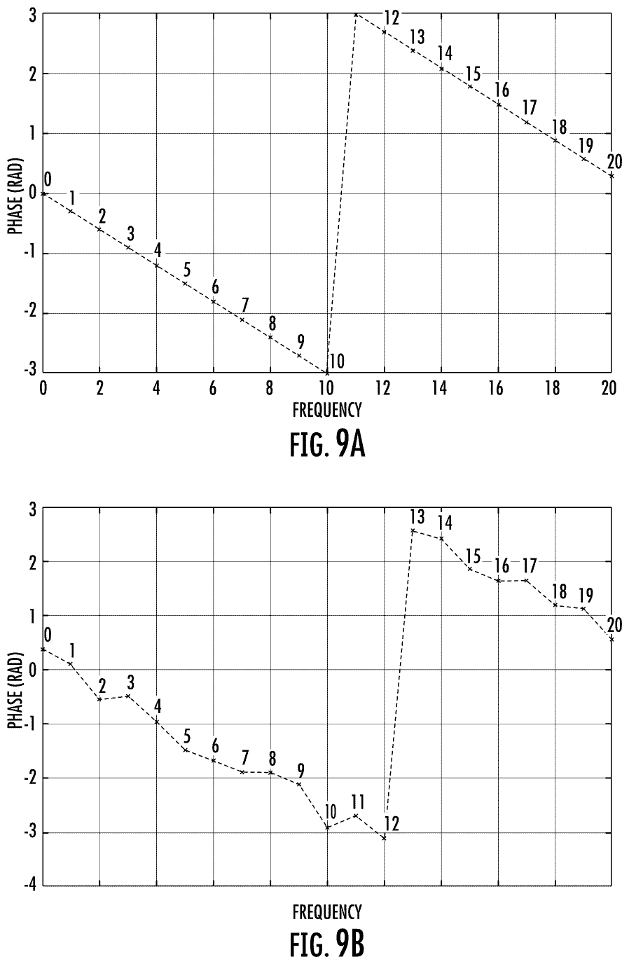

As shown in FIG. 9A, when the two devices are stationary and there is no multipath reflections, there should be a nearly linear relationship between frequency under test and the unwrapped phase. Thus, in Box 320, the smoothness of the sorted compensated channel frequency response is determined. This may be done in many different ways. In one embodiment, a Savitsky-Golay filter is applied to the sorted compensated channel frequency response to create a smoothed response. The Savitsky-Golay filter may be configured with a filter order of 3 and a window size of 5 in some embodiments. The difference between the sorted compensated channel frequency response and the smoothed channel frequency response is then calculated and referred to as the error. This difference may be calculated using a 2-norm of the sorted compensated channel frequency response and the smoothed channel frequency response. In another embodiment, a least squares fit is applied to the sorted compensated channel frequency response to create a smoothed channel frequency response. Again, the difference between the sorted compensated channel frequency response and the smoothed channel frequency response is then calculated. Of course, other smoothing filters may also be used to create the smoothed channel frequency response. For example, a moving average filter having a relatively small window size, such as 3,5 or 7 may be used. In some embodiments, this comparison is performed using unwrapped phase values. In other words, the difference may be calculated based on the sorted compensated channel frequency response using unwrapped phase values, and the resulting smoothed channel frequency response, which also includes unwrapped phase values.

Further, note that the phase de-rotation performed above results in a value having an amplitude and a phase. In some embodiments, the smoothing and error calculations are performed using only the phase component of that de-rotation result.

As shown in Box 325, if the error that was just calculated is smaller than any of the previous calculated errors, this phi (φ) value is saved and may be referred to as correct_phase.

The value of phi (φ) is then incremented by a variable referred to as phi_step, as shown in Box 330. The size of phi_step determines the granularity of the radial speed. The choice of phi_step represents a trade-off between precision and computation time, as smaller phi_step values create more precise results but require more iterations of Boxes 310-330.

The algorithm then checks if the new value of phi (φ) is less than the maximum phi value to be evaluated, as shown in Decision Box 335. If it is smaller, the loop that comprises Boxes 310-330 is repeated. If the entire range of phi (φ) values has been checked, the radial speed can be computed, as shown in Box 340. Knowing the values of correct_phase, tₛ and λ allows the computation of the radial speed, using the equation given above, which results in:

$$v = \frac{φλ}{4 π {t}_{s}}$$

Additionally, as shown in Box 345, a corrected phase compensated channel frequency response, referred to as H²_{cc}(0:k−1) may be computed as H²ᵤ(N)e^{i*N*correct_phase} for N from 0 to k−1.

Finally, as shown in Box 350, the corrected phase compensated channel frequency response is reordered in accordance with increasing frequencies to create the corrected sorted phase compensated channel frequency response, or H²_{csc}(f). The corrected sorted phase compensated channel frequency response may then be used to compute the distance between the devices. The corrected sorted phase compensated channel frequency response may be provided to any algorithm for spectral analysis, such as Multiple Signal Classification (MUSIC), MATRIX PENCIL, Inverse Fast Fourier Transform (IFFT) or others.

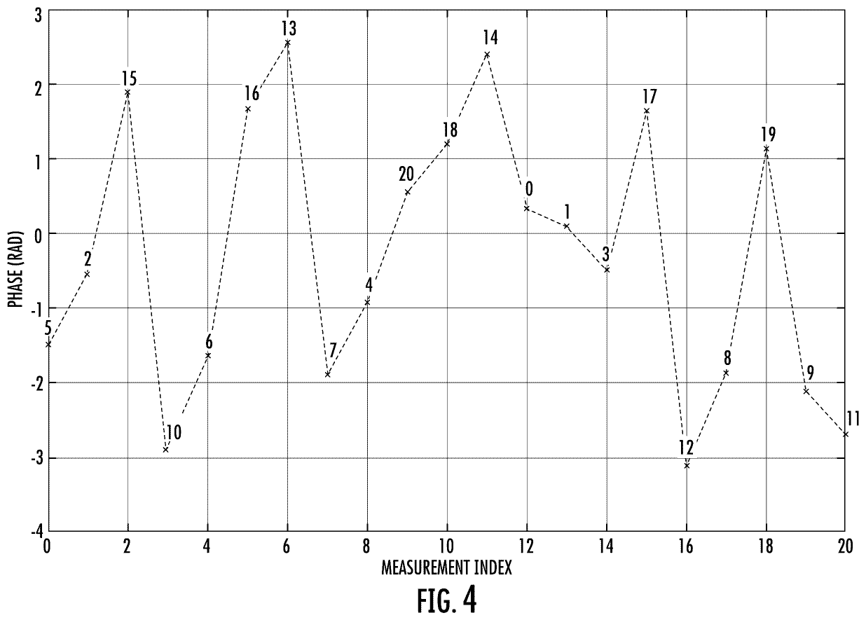

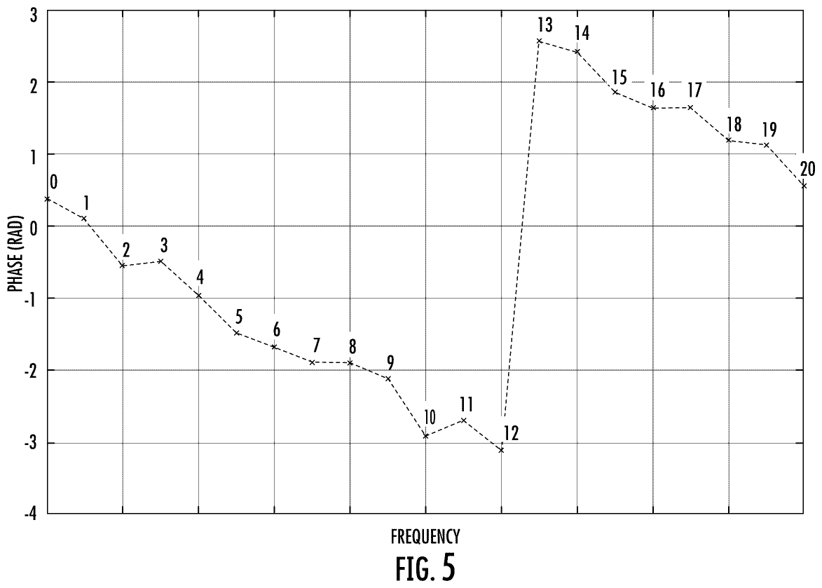

An example of this method is shown in FIGS. 4-7. FIG. 4 shows a graph of phase versus sample index (k) obtained using a simulation. This is representative of what may be generated using the Channel Sounding procedure. Note that this graph represents the chronologically ordered but not frequency ordered channel frequency response H²ᵤ(0:k−1) described above. The numbers located near each point on the graph are indicative of the frequency that was being tested. Thus, point 19 denotes a frequency that is greater than point 18 but less than point 20. FIG. 5 shows the data in FIG. 4 sorted in accordance with increasing frequency.

This corresponds to an H²_{sc}(0:k−1) for a phi (φ) value of 0. Note that there is not a linear relationship between the frequency tested and the measured phase.

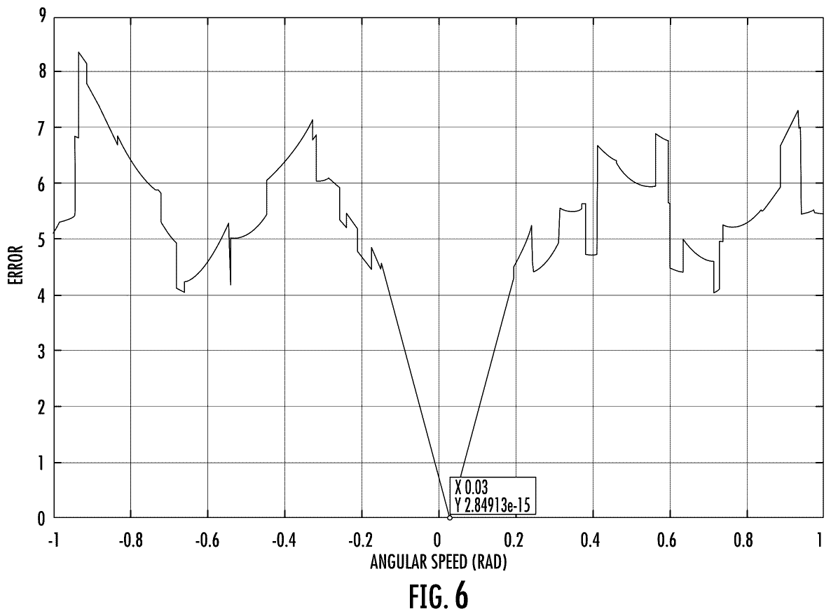

Various values of phi (φ) from −1 to +1 were then used to de-rotate the H²ᵤ(0:k−1) channel frequency response to create a plurality of phase compensated channel frequency responses H²_{c}(0:k−1), as described above. A smoothing filter was then applied to each of these plurality of phase compensated channel frequency responses and the error associated with each phi value is plotted in FIG. 6. Note that the unwrapped phase from FIG. 5 was used in this error calculation. Note that the minimum error occurs when the phi (φ) value is 0.03.

Note that in some embodiments, the algorithm may also store the maximum error calculated. The difference between the maximum error and the minimum error may be used as a quality indicator, wherein a larger difference indicates a more reliable channel correction and speed estimate.

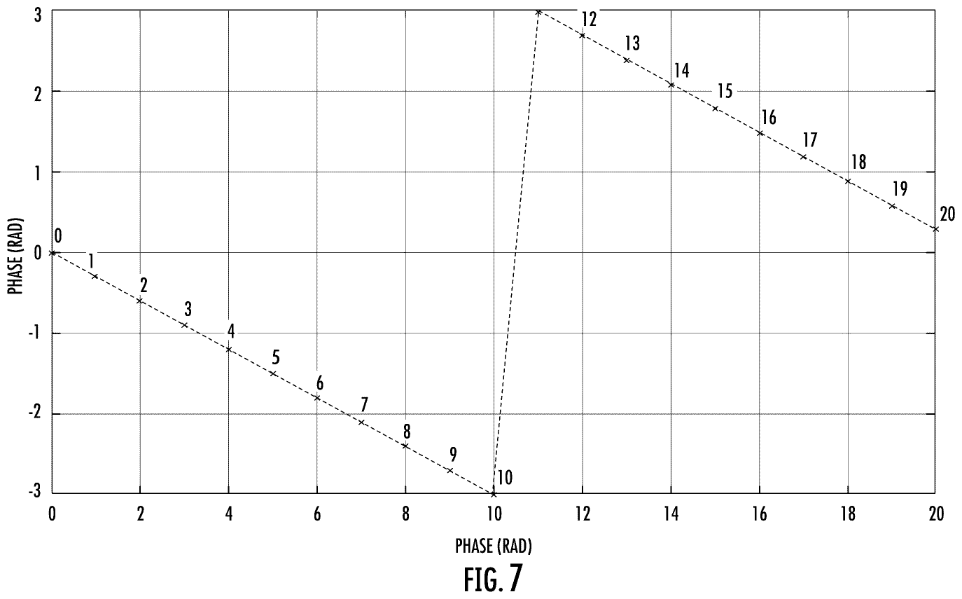

This phi (φ) value is then used to de-rotate the H²ᵤ(0:k−1) channel frequency response to create the corrected phase compensated channel frequency response, H²_{cc}(0:k−1). This corrected phase compensated channel frequency response is then sorted in accordance with increasing frequency to create the corrected sorted phase compensated channel frequency response, H²_{csc}(f), which is shown in FIG. 7. Note that, in comparison to FIG. 5, the slope of the line is much more linear. Also note that by removing the radial speed, the frequency at which the phase wraps has changed. Thus, the corrected sort phase compensated channel frequency response shown in FIG. 7 may be used by any spectral analysis tool, such as MUSIC, to determine the distance between the initiator device 10 and the reflector device 110. In another embodiment, the radial speed and the output from the spectral analysis tool may be supplied to a Bayesian filter, such as a particle filter or a Kalman filter, which may be used as a post-filter to improve the accuracy and remove potential outliers.

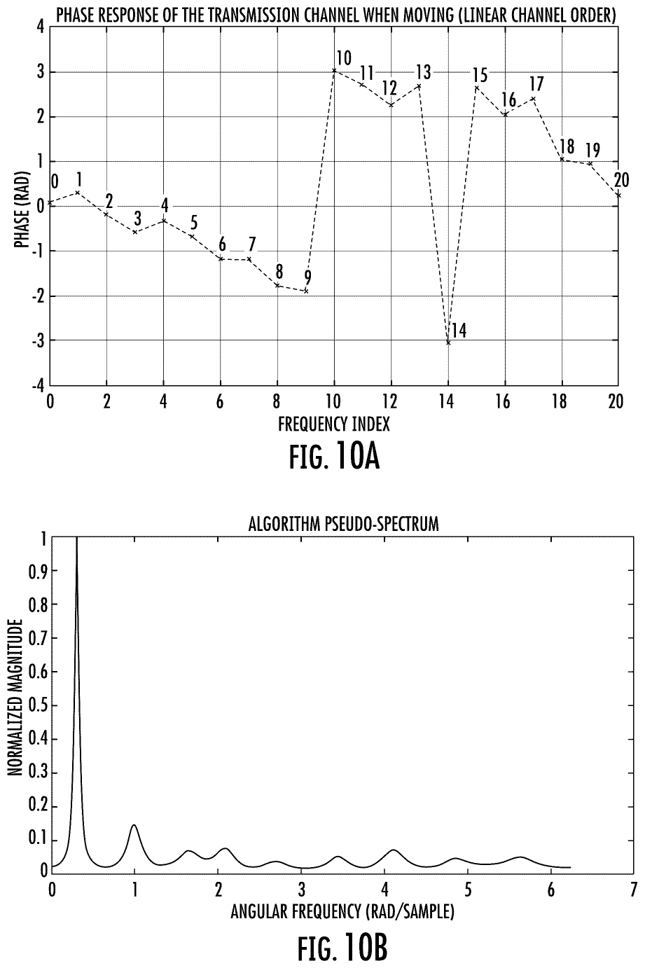

FIGS. 10A-10B, 11A-11C and 12A-12B show another example of the effectiveness of this approach. In these figures, it is assumed that the target device is located in an environment that generates multipath reflections. It is also assumed that the target device is moving. FIG. 10A shows the graph of phase versus frequency index (k) obtained using a simulation. This is representative of what may be generated using the Channel Sounding procedure, after being sorted according to frequency. The numbers located near each point on the graph are indicative of the frequency that was being tested. Thus, point 19 denotes a frequency that is greater than point 18 but less than point 20. Note that there is not a linear relationship between the frequency tested and the measured phase. FIG. 10B shows the spectral analysis of the waveform of FIG. 10A. This spectral analysis may be used to determine the distance between the two devices. Note that there are several distinct peaks, which may relate to the actual path and two reflected paths. Note that each peak is relatively wide at its base.

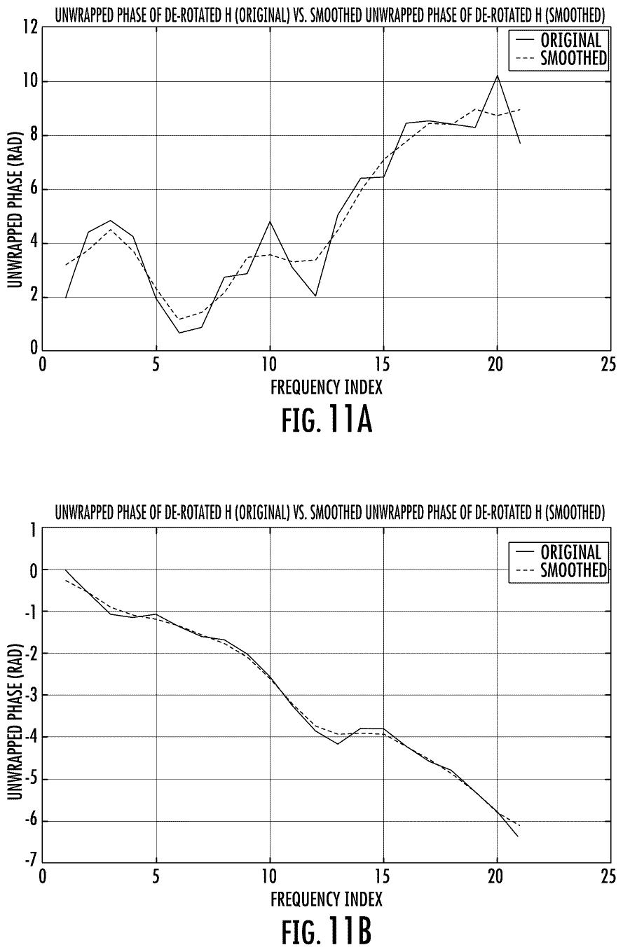

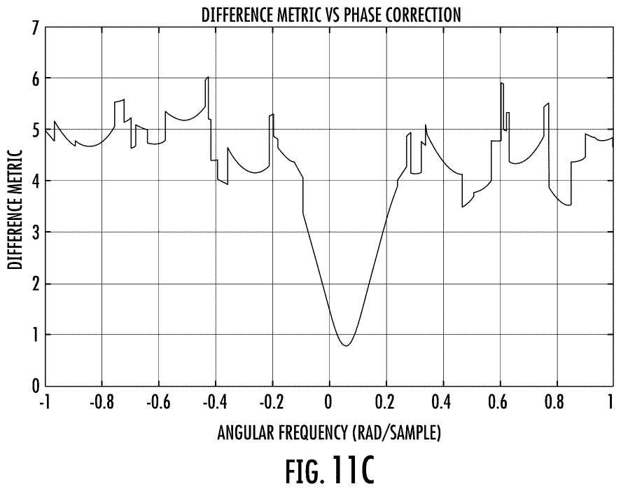

Various values of phi (φ) from −1 to +1 were then used to de-rotate the H²ᵤ(0:k−1) channel frequency response to create a plurality of phase compensated channel frequency responses H²_{c}(0:k−1), as described above. Note that this is performed using the channel frequency response that is chronologically ordered. A smoothing filter was then applied to each of these plurality of phase compensated channel frequency responses after they are sorted according to increasing frequency. FIGS. 11A-11B show two phase compensated channel frequency responses and the associated smoothed version after the smoothing filter has been applied. In these graphs, the smoothing filter comprises a moving average. Note that the phi value used for FIG. 11B is much closer to the actual value than that used in FIG. 11A. The error associated with each value of phi, which is based on the difference between the phase compensated channel frequency response and the smoothed version of that channel response, is plotted in FIG. 11C. Note that the unwrapped phase was used in this error calculation. Note that the minimum error occurs when the phi (φ) value is 0.05.

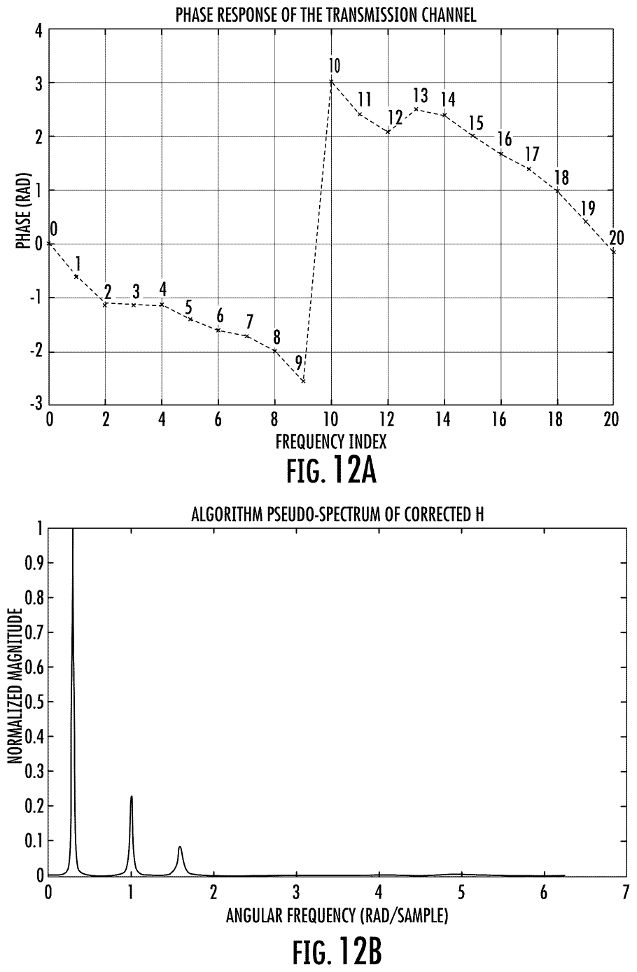

This phi (φ) value is then used to de-rotate the H²ᵤ(0:k−1) channel frequency response to create the corrected phase compensated channel frequency response, H²_{cc}(0:k−1). This corrected phase compensated channel frequency response is then sorted in accordance with increasing frequency to create the corrected sorted phase compensated channel frequency response, H²_{csc}(f), which is shown in FIG. 12A. Note that, as shown in FIG. 12B, the spectral analysis of the graph of FIG. 12A yields one strong peak and one or more minor peaks. Further, these peaks are much more narrow that those in FIG. 10B, and the background noise between peaks is greatly reduced. Thus, the spectral analysis is much more likely to correctly determine the distance between the two devices.

These figures are intended to show that the algorithm is also effective when disposed in an environment having multipath reflections. This algorithm helped reduce noise and accentuate the peaks that correspond to the actual distance and the reflected distances.

Also note that this algorithm is effective even if there is no radial speed. In that scenario, the algorithm will determine that a phi value of 0 is the most appropriate, which corresponds to a radial speed of 0.

There are various modifications that may be made to the sequence shown in FIG. 3. For example, in some embodiments, the frequencies that are tested are not equally spaced apart. Thus, the smoothing function may not be applied on the entirety of the sorted phase corrected channel frequency response at once. Rather, the sorted phase corrected channel frequency response may be separated into 2 or more segments that are each continuous. In other words, the frequencies in each segment are equally spaced apart. Smoothing filters are then applied on each segment and the errors can then be calculated for each segment and then summed to determine the total error.

While FIG. 3 checks the smoothness of each sorted phase compensated channel frequency response for each phi (φ) value, other embodiments are possible. For example, Monte Carlo sampling may be used to find the minimum.

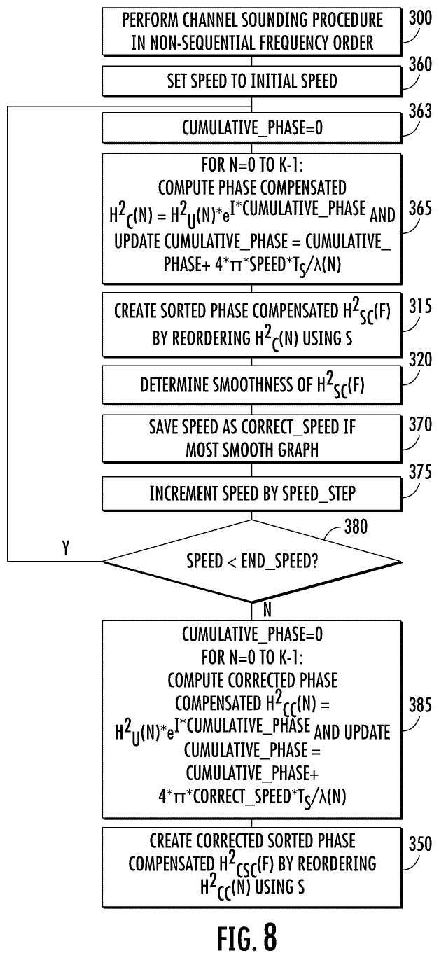

Further, in some embodiments, a constant value of phi (φ) may not be used for all of the frequencies. Specifically, the phase associated with a particular radial speed is also related to the frequency that was being tested. Thus, a more exact definition of phase is defined as:

$$φ ( k ) = \frac{4 π {vt}_{s}}{λ ( k )}$$

wherein λ(k) is the wavelength for the k^{th} frequency that was tested. Note that this equation assumed that the channel frequency response is H²(f). If H(f) is used, the numerator is reduced by a factor of two. Thus, in Box 305, rather than using a range of phi (φ) values, a range of radial speeds are defined. These radial speeds are then converted into phi values. FIG. 8 shows the modified sequence that may be used for this embodiment. In this sequence, a range of speeds, from initial speed to end_speed are defined. Additionally, the speed step size is also defined. After the initial H²ᵤ(0:k−1) channel frequency response is obtained, it is de-rotated as described above. However, the term used for the de-rotation is now cumulative_phase, which is defined as the cumulative sum of

$$\frac{4 π * speed * {t}_{s}}{λ ( N )}$$

for all N less than the current value of N, as shown in Box 365. Note that this term is equivalent to φ(N), as shown in the equation above. Note that, in some embodiments, ts may not be constant for all frequencies. Thus, in some embodiments, the cumulative phase may be defined as the cumulative sum of

$$\frac{4 π * speed * {t}_{s} ( N )}{λ ( N )}$$

for all N less than the current value of N. The speed is initialized before the algorithm is executed, as shown in Box 360. Additionally, cumulative_phase is initialized before being used to compute the phase compensated channel frequency response, as shown in Box 363. Further, Box 370 replaces Box 325, where the speed that is associated with the smoothest graph is saved as correct_speed. Further, in Box 375, the speed is incremented by speed_step and the comparison is made to end_speed in Decision Box 380. Finally, the corrected phase compensated channel frequency response (H²_{cc}(0:k−1)) is calculated using the cumulative_phase, which is calculated using the correct_speed, as shown in Box 385. The other processes are the same as shown in FIG. 3.

Note that this computation may be performed by the initiator device 10. The initiator device 10 may contain the requisite computation power and memory space to perform these calculations. Alternatively, the initiator device 10 may off-load the calculations to a computational device (not shown).

The present system has many advantages. First, this method utilizes a small memory footprint, as few values need to be stored. Second, this algorithm is very fast to compute and does not require the Channel Sounding procedure to be executed multiple times. Importantly, the radial speed can be determined using a single channel transfer function created by a Channel Sounding procedure.

Additionally, this system and method produces a corrected phase compensated channel frequency response that has removed the radial speed from the measurements. This corrected phase compensated channel frequency response may be used by any suitable spectral analysis tool to determine the distance between the devices. Thus, this method does not mandate the use of any particular distance measuring algorithm. Rather, it simply provides a channel frequency response that allows for the determination of a more accurate result, regardless of the distance measuring algorithm that is used.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A method of calculating a radial speed between two wireless network devices, comprising:
performing a Channel Sounding procedure at a plurality of frequencies to obtain a channel frequency response; and
using the channel frequency response to determine the radial speed.

2. The method of claim 1, wherein the channel frequency response is de-rotated using a plurality of different phase values to create a plurality of phase compensated channel frequency responses, and one of the plurality of different phase values is selected as a correct phase; and wherein the radial speed is computed using the correct phase.

3. The method of claim 2, wherein the correct phase is a phase associated with the phase compensated channel frequency response determined to be the most smooth.

4. The method of claim 3, wherein determining the most smooth phase compensated channel frequency response comprises:
applying a smoothing filter on each of the phase compensated channel frequency responses to create a plurality of smoothed responses;
generating a plurality of error values by calculating a difference between each of the phase compensated channel frequency responses and their respective smoothed response; and
determining the phase compensated channel frequency response associated with a smallest error to be the most smooth.

5. The method of claim 4, wherein the smoothing filter comprises a Savitsky-Golay filter or a moving average.

6. The method of claim 4, wherein the plurality of frequencies are not tested in ascending order in the Channel Sounding procedure, and wherein the channel frequency response is sorted in accordance with increasing frequency prior to applying the smoothing filter.

7. The method of claim 2, wherein the plurality of different phase values comprise a range of equally spaced apart phase values.

8. The method of claim 2, wherein the plurality of different phase values comprises phase values calculated using a range of equally spaced apart radial speeds.

9. The method of claim 1, further comprising generating a corrected phase compensated channel frequency response by eliminating the radial speed from the channel frequency response.

10. The method of claim 9, further comprising determining a distance between the two wireless network devices by utilizing a spectral analysis tool on the corrected phase compensated channel frequency response.

11. A Bluetooth network, comprising:
a reflector device; and
an initiator device, comprising:
a Bluetooth network interface;
a processing unit; and
a memory device, wherein the memory device comprises instructions, which when executed by the processing unit, enable the initiator device to:
calculate a channel frequency response at a plurality of frequencies; and
use the channel frequency response to determine a radial speed between the initiator device and the reflector device.

12. The Bluetooth network of claim 11, wherein the channel frequency response is de-rotated by the initiator device using a plurality of different phase values to create a plurality of phase compensated channel frequency responses, and one of the plurality of different phase values is selected as a correct phase; and the radial speed is computed using the correct phase.

13. The Bluetooth network of claim 12, wherein the correct phase is a phase associated with the phase compensated channel frequency response determined to be the most smooth.

14. The Bluetooth network of claim 13, wherein the initiator device comprises instructions to determine the most smooth phase compensated channel frequency response, wherein the instructions, when executed by the processing unit, enable the initiator device to:
apply a smoothing filter on each of the phase compensated channel frequency responses to create a plurality of smoothed responses;
generate a plurality of error values by calculating a difference between each of the phase compensated channel frequency responses and their respective smoothed response; and
determine the phase compensated channel frequency response associated with a smallest error to be the most smooth.

15. The Bluetooth network of claim 14, wherein the smoothing filter comprises a Savitsky-Golay filter or a moving average.

16. The Bluetooth network of claim 14, wherein the plurality of frequencies are not tested in ascending order to create the channel frequency response, and wherein the channel frequency response is sorted by the initiator device in accordance with increasing frequency prior to applying the smoothing filter.

17. The Bluetooth network of claim 12, wherein the plurality of different phase values comprise a range of equally spaced apart phase values.

18. The Bluetooth network of claim 12, wherein the plurality of different phase values comprises phase values calculated using a range of equally spaced apart radial speeds.

19. The Bluetooth network of claim 11, wherein the memory device further comprises instructions, which when executed by the initiator device, enable the initiator device to: generate a corrected phase compensated channel frequency response by eliminating the radial speed from the channel frequency response.

20. The Bluetooth network of claim 19, wherein the memory device further comprises instructions, which when executed by the initiator device, enable the initiator device to: determine a distance between the initiator device and the reflector device by utilizing a spectral analysis tool on the corrected phase compensated channel frequency response.
